(19) United States
(12) Patent Application Publication
(10) Pub. No.: US 2013/0133486 A1
(43) Pub. Date: May 30, 2013

(54) BENDING MECHANISM OF HAND TOOL AND HAND TOOL INCLUDING THE SAME

(71) Applicant: Hui-Chien CHEN, Taichung (TW)

(72) Inventor: Hui-Chien CHEN, Taichung (TW)

(21) Appl. No.: 13/305,287

(22) Filed: Nov. 28, 2011

(51) Int. Cl. F16C 11/04; B25B 13/46

(52) U.S. Cl. 81/60; 464/106

(57) ABSTRACT

The bending mechanism of hand tool of the present invention includes a body and a bending portion. A working portion is formed at one end of the body, and a holding portion is formed at the other end of the body. The bending portion is disposed between the working portion and the holding portion and includes a pivot trough and a pivot end which is arranged in the pivot trough. The pivot trough has a trough opening and a limiting structure. The pivot end is able to move between a first position and a second position. The pivot end is unable to bend pivotally at the first position, but is able bend pivotally at the second position. The hand tool of the present invention includes the bending mechanism and a ratchet wheel head connected with the working portion.

### BACKGROUND OF THE INVENTION

1. Field of the Invention

The present invention relates to a bending mechanism of hand tool and a hand tool including the bending mechanism.

2. Description of the Prior Art

Hand tools are wildly used in maintenance of machinery industry. But most machines have complicated structures, and the position to work with is often distant from a user. If a body of a hand tool is not long enough to hold on, operating will be laborious and difficult. Besides, the space of operating is often small and narrow. If the body of a hand tool is long enough, the body is often obstructed by other components of the machine. In that, the body of the hand tool is difficult to operate.

### SUMMARY OF THE INVENTION

The main object of the present invention is to provide a bending mechanism of hand tool and a hand tool including the same.

To achieve the above and other objects, the bending mechanism of hand tool of the present invention includes a body and at least one bending portion. The hand tool of the present invention includes said bending mechanism and a ratchet wheel head.

A holding portion is formed at one end of the body, and a working portion is formed at the other end of the body. The bending portion includes a pivot trough and a pivot end and is disposed between the holding portion and the working portion. A top of the pivot trough has a trough opening, and a U-shaped opening is formed axially on a wall of the pivot trough. The opening communicates with the trough opening. The pivot end is arranged in the pivot trough and is able to move between a first position and a second position. A limiting structure of the pivot trough disenables the pivot end to bend pivotally when the pivot end is at the first position. When the pivot end is at the second position, the pivot end is able to bend pivotally in the pivot trough, and then the body becomes generally L-shaped. The pivot end can pivot to only the direction of the opening due to a side of the wall of the pivot trough which is opposite to the opening is closed. Besides, the bending portion also includes at least one positioning assembly which includes a first positioning element. The first positioning element is able to move in a sliding slot on the pivot end. The first positioning element is located on one end of the sliding slot when the pivot end is at the first position, and the second positioning element is located on the other end of the sliding slot when the pivot end is at the second position.

The hand tool of the present invention includes the bending mechanism as mentioned above and a ratchet wheel head. A polyhedron is formed on the working portion, and a coupling portion is disposed on the polyhedron. The coupling portion fixes the ratchet wheel head to the working portion.

Thereby, the bending mechanism of hand tool and the hand tool including the same of the present invention are much easier to use and improve the drawbacks of the prior art.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a bending mechanism of hand tool and a hand tool including the same of the present invention;

FIG. 2 is a breakdown drawing showing a bending mechanism of hand tool and a hand tool including the same of the present invention;

FIG. 2A is a partial enlargement view of FIG. 2;

FIG. 3 is a side view showing a pivot end at a first position of the present invention;

FIG. 3A is a partial enlargement perspective view showing a pivot end at a first position of the present invention;

FIG. 4 is a side view showing a pivot end at a second position of the present invention;

FIG. 4A is a partial enlargement perspective view showing a pivot end at a second position of the present invention;

FIG. 5 is an illustration of bending of the present invention;

FIG. 6 is a partial breakdown drawing of a second embodiment of a hand tool of the present invention;

FIG. 7 is an illustration of a third embodiment of a hand tool of the present invention;

FIG. 7A is a partial breakdown drawing of a third embodiment of a hand tool of the present invention;

FIG. 7B is a partial perspective side view of a third embodiment of a hand tool of the present invention;

FIG. 8 is an illustration of a fourth embodiment of a hand tool of the present invention;

FIG. 8A is an illustration of bending of a fourth embodiment of a hand tool of the present invention.

### DETAILED DESCRIPTION OF THE PREFERRED EMBODIMENTS

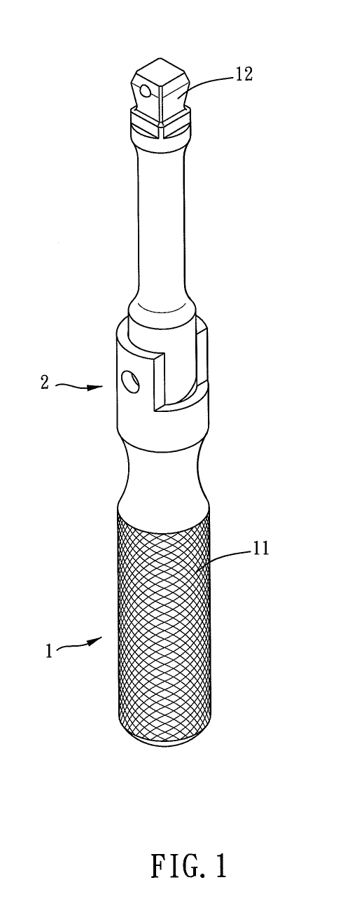

Please refer to FIG. 1 to FIG. 6, the bending mechanism of hand tool of the present invention includes a body 1 and at least one bending portion 2. The hand tool of the present invention includes the bending mechanism as mentioned above and a ratchet wheel head 3.

Please refer to FIG. 1 to FIG. 3, in the first embodiment of the present invention, one end of the body 1 forms a holding portion 11, and the other end of the body 1 forms a working portion 12. The bending portion 2 is disposed between the holding portion 11 and the working portion 12 and includes a pivot trough 21 and a pivot end 22. The pivot end 22 is arranged in the pivot trough 21. The pivot trough 21 has a trough opening 211 and a limiting structure. The pivot end 22 has a sliding slot 221 and is able to move between a first position and a second position. The pivot end 22 is unable to bend pivotally due to the limiting structure at the first position.

A recess 21 is formed on the bottom of the pivot trough 21, and the pivot end 22 contacts with the recess 21 at the first position. Besides, the limiting structure includes two opposite propping ladders 213,213′ and two opposite side faces 214,214′. A positioning hole 215 is formed on one side face 214, and a positioning aperture 216 is formed on the other side face 214′. A U-shaped opening 217 is formed axially on a wall of the pivot trough 21, and the opening 217 communicates with the trough opening 211. The two side faces 214,214′ are located on the wall of the pivot trough 21, and the two side faces 214,214′ are not adjacent to each other. When bending pivotally, the pivot end 22 leans against the opening 217.

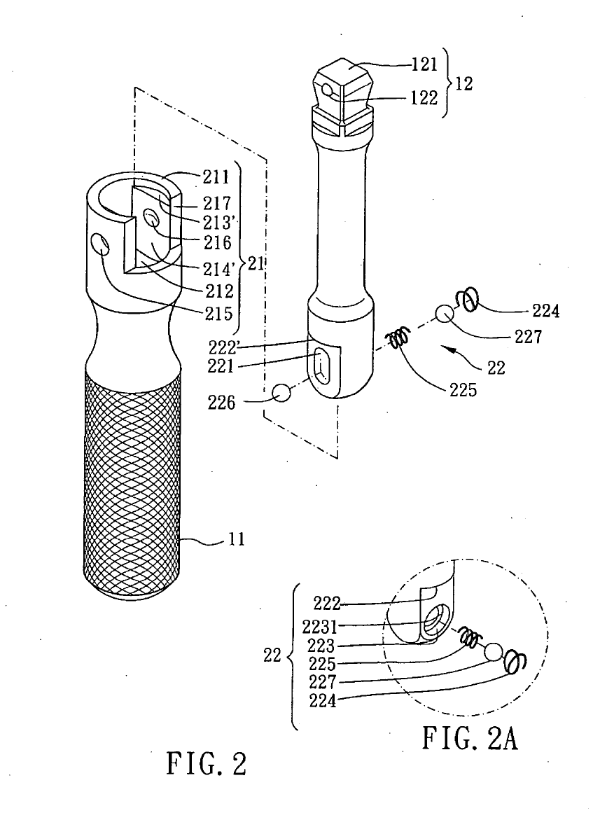

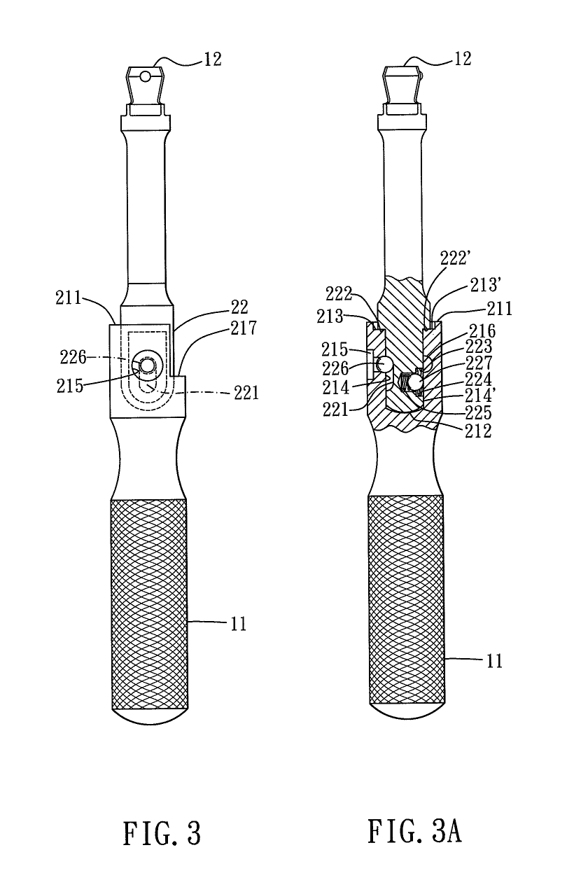

Please refer to FIG. 2 and FIG. 2A. Two leaning faces 222,222′ are formed on the outer wall of the pivot end 22. The pivot end 22 also forms a receiving hole 223 corresponding to the positioning aperture 216. The sliding slot 221 corresponds to the positioning hole 215. Besides, the bending portion 2 also includes a positioning assembly having a first elastic element 224, a second elastic element 225, a first positioning element 226, and a second positioning element 227, wherein the first positioning element 226 is able to move in the sliding slot 221. The first elastic element 224, the second elastic element 225 and the second positioning element 227 are received in the receiving hole 223, wherein the second positioning element 227 is disposed between the first elastic element 224 and the second elastic element 225. The first positioning element 226 is sandwiched between the sliding slot 221 and the positioning hole 215, as shown in FIG. 3 and FIG. 3A. In the major embodiment of the present invention, the first positioning element 226 and second positioning element 227 are balls respectively. Besides, the receiving hole 223 has a ladder face 2331. One end of the first elastic element 224 presses against the ladder face 2331, and the other end of the first elastic element 224 presses against the side face 214′ with the positioning aperture 216.

Please refer to FIG. 3A. When the pivot end 22 is at the first position, the second positioning element 227 is received in the receiving hole 223 and does not correspond to the positioning aperture 216. Also, the second positioning element 227 presses the second elastic element 225, and the first positioning element 226 is located on the end of the sliding slot 221 near the working portion 12. The first elastic element 224 continuously presses against the side face 214′ with the positioning aperture 216 so that the pivot end 22 is able to received in the pivot trough 21 and to tightly contact with the recess 212. Furthermore, the two leaning faces 222, 222′ lean against the two propping ladders 213, 213′ respectively, so that the pivot end 22 is unable to pivot in any direction.

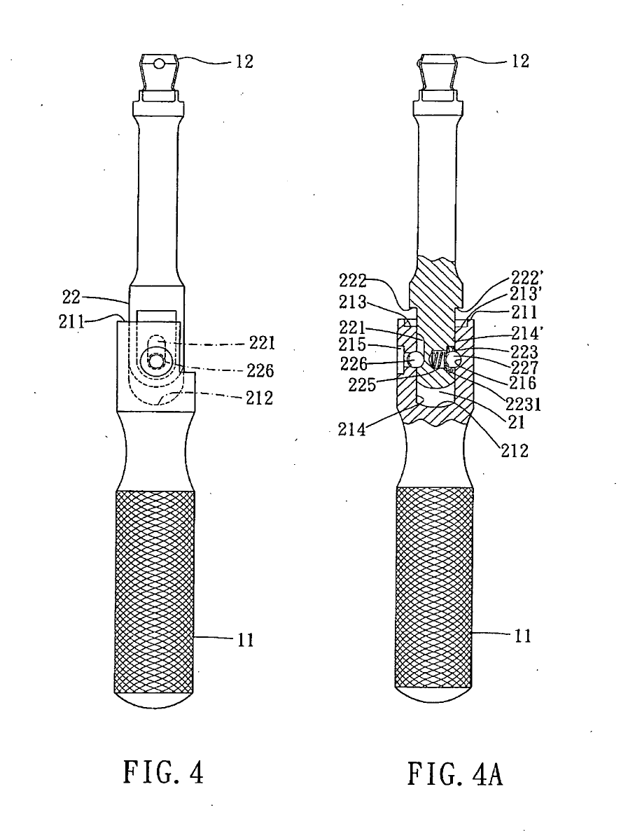

Please refer to FIG. 4 and FIG. 4A. When the pivot end 22 moves to the second position, the pivot end 22 is deviated from the recess 212, and the two leaning faces 222, 222′ are also deviated from the two propping ladders 213, 213′ respectively. In the mean while, the second positioning element 227 moves to the position corresponding to the positioning aperture 216 and then is received in the positioning aperture 216 due to the elastic force by the second elastic element 225. As such, the pivot end 22 is unable to move forwards and is fixed at the second position. Besides, when the pivot end 22 is at the second position, the first positioning element 226 moves from the end of the sliding slot 221 near the working portion 12 to the end of the sliding slot 221 near the holding portion 11, as shown in FIG. 4.

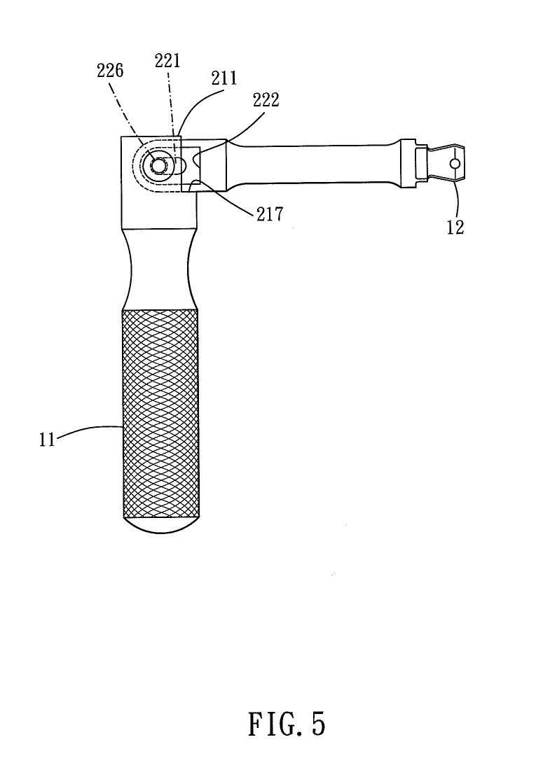

Please refer to FIG. 4 and FIG. 5, when the pivot end 22 is fixed at the second position, the holding portion 11 is able to bend pivotally relatively to the working portion 12, and the holding portion 11 is generally perpendicular to the working portion 12. The body 1 is generally L-shaped. More precisely, the angle between the holding portion 11 and the working portion 12 is 90 degrees, slightly small than 90 degrees, or slightly larger than 90 degrees. In the meanwhile, the pivot end 22 leans against the opening 217. Otherwise, the pivot end 22 is able to pivot to the direction of the opening 217 because the side of the wall of the pivot trough 21 opposite to the opening 217 is closed.

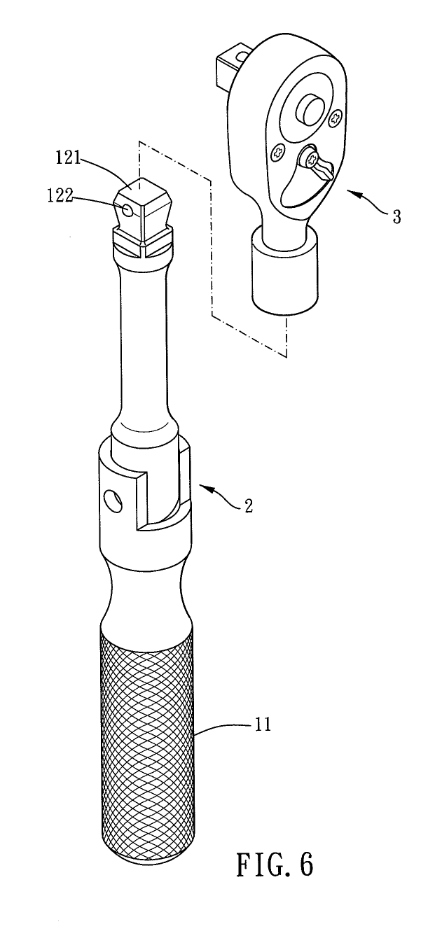

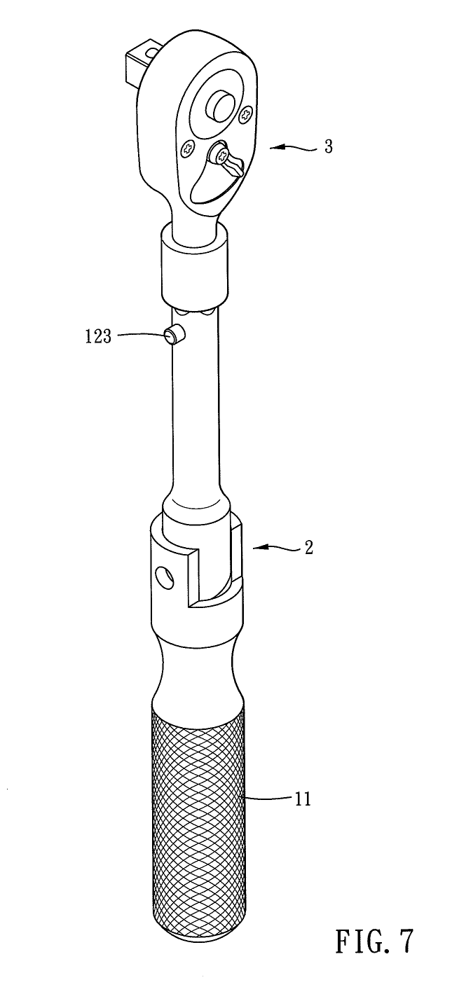

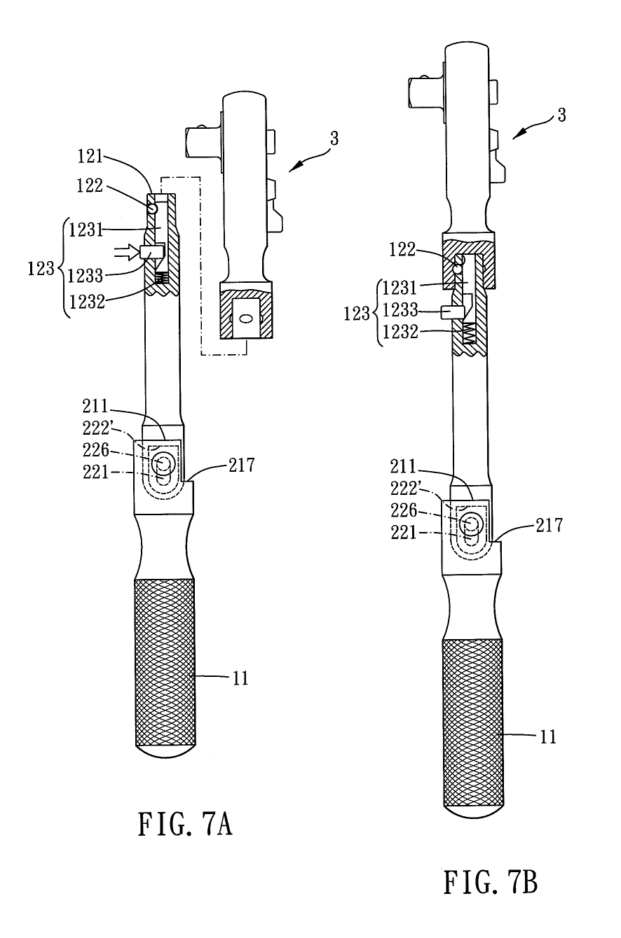

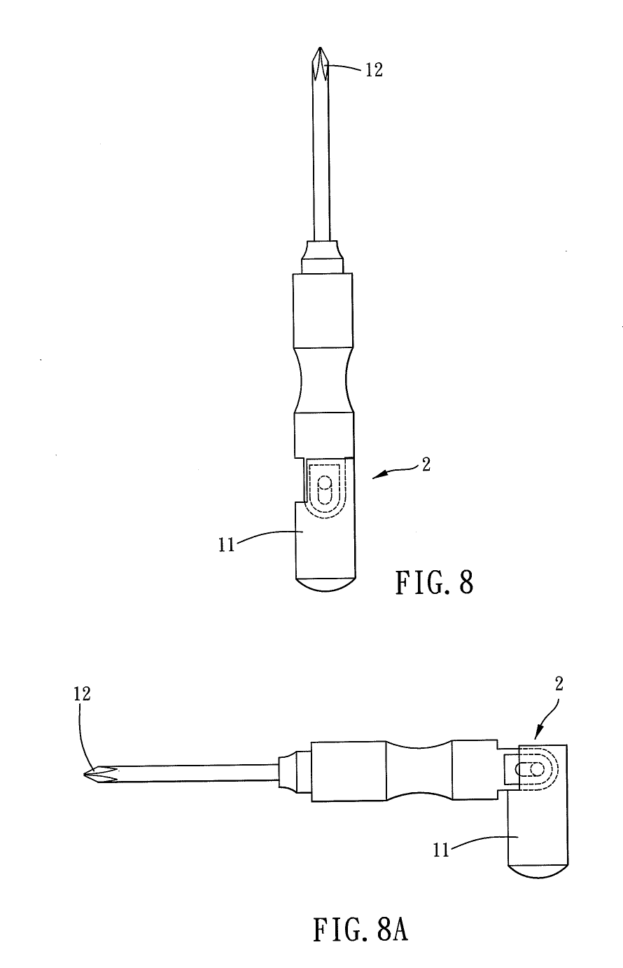

The hand tool of the present invention provides possibility of combination to accommodate with different working situations, as shown in FIG. 6, FIG. 7, FIG. 7A, FIG. 7B, FIG. 8, and FIG. 8A.

Please refer to FIG. 6, in the second embodiment of the present invention, the hand tool includes a ratchet wheel head 3. A polyhedron 121 is formed on the working portion 12, and a coupling portion 122 is disposed on the polyhedron 121.

The coupling portion 121 fixes the ratchet wheel head 3 to the working portion 12, wherein the coupling portion 121 can be a ball, as shown in FIG. 2 and FIG. 6. In other possible embodiments, the ball can be replaced by a blocker or a boss.

Please refer to FIG. 7, in the third embodiment of the present invention, the working portion 12 has a switch 123 to control the action of the coupling portion 122. Please refer to FIG. 7A and FIG. 7B, the switch 123 includes a movable rod 1231, a spring 1232 and a button 1233, wherein the movable rod 1231 and the spring 1232 are received in the working portion 12. When the button 1233 is pressed, the movable rod 1231 presses the spring 1232 to make the coupling portion 122 be received in the working portion 12. Such that, the ratchet wheel head 3 is able to be detached from the working portion 12. When the button 1233 is released, the movable rod 1231 is pressed by the spring 1232, and then the coupling portion 122 is pushed by the movable rod 1231 and is exposed out of the working portion 12. As such, the ratchet wheel head 3 is able to engage with the working portion 12 firmly.

Furthermore, in the fourth embodiment of the present invention, as shown in FIG. 8 and FIG. 8A, the working portion 12 can be manufactured as a screwdriver or other structures like spanners. Besides, the bending portion 2 is arranged near the holding portion 11, so controlling the bending becomes easier and more convenient.

1. A bending mechanism of hand tool including:
a body, a working portion being formed at one end of the body, a holding portion being formed at the other end of the body;
at least one bending portion, including a pivot trough and a pivot end, the bending portion being located between the working portion and the holding portion, the pivot end being arranged in the pivot trough, an axial direction being defined from the pivot end to the working portion, the pivot trough having a trough opening and a limiting structure, the pivot end having a sliding slot extending along the axial direction, the sliding slot having a first end near the working portion and a second end away from the working portion, the pivot end being movable between a first position and a second position relative to the pivot trough, the pivot end being unable to bend pivotally due to the limiting structure when the pivot end is at the first position, the pivot end being able to bend pivotally in the trough opening and the body being generally L-shaped when the pivot end is at the second position;
wherein the bending portion includes at least one positioning assembly having a first positioning element, the first positioning element is able to move relatedly in the sliding slot, the first positioning element is at the first end of the sliding slot when the pivot end is located at the first position, the first positioning element is at the second end of the sliding slot when the pivot end is located at the second position.

2. The bending mechanism of hand tool of claim 1, wherein a recess is formed on the bottom of the pivot trough, the pivot end contacts with the recess when the pivot end is at the first position.

3. The bending mechanism of hand tool of claim 2, wherein the limiting structure includes two propping faces and two opposite side faces, a positioning hole is formed on one of the side faces, a positioning aperture is formed on the other side face, two leaning faces are formed on the pivot end, the two leaning faces lean on the two propping faces respectively in order to disenable the holding portion to bend pivotally relatively to the working portion when the pivot end is at the first position.

4. The bending mechanism of hand tool of claim 3, wherein the pivot end has a receiving hole which corresponds to one of the positioning hole and the positioning aperture, the sliding slot corresponds to the other of the positioning hole and the positioning aperture.

5. The bending mechanism of hand tool of claim 4, wherein the positioning assembly also includes a first elastic element, a second elastic element, and a second positioning element, the first elastic element, the second elastic element, and the second positioning element are received in the receiving hole, the second positioning element is arranged between the first elastic element and the second elastic element.

6. The bending mechanism of hand tool of claim 5, wherein the first positioning element and the second positioning element are balls.

7. The bending mechanism of hand tool of claim 4, wherein a U-shaped opening is formed on a wall of the pivot trough axially, the opening communicates with the trough opening, the two side faces are located on the wall of the trough and are located on the two opposite sides of the opening respectively, the pivot end leans against the opening when the pivot end bends pivotally.

8. The bending mechanism of hand tool of claim 7, wherein the receiving hole has a ladder face, one end of the first elastic element presses against the ladder face, the other end of the first elastic element presses against one of the two side faces.

9. A hand tool including the bending mechanism of hand tool of claim 1 and a ratchet wheel head, wherein a polyhedron is formed on the working portion, a coupling portion is disposed on the polyhedron, the coupling portion fixes the ratchet wheel head to the working portion.
